(19) United States
(12) Patent Application Publication
(10) Pub. No.: US 2003/0183539 A1
(43) Pub. Date: Oct. 2, 2003

(54) Method of measuring copper ion concentration in industrial electrolytes

(76) Inventors: Przemyslaw Los, Wroclaw (PL); Boguslaw Fuglewicz, Wroclaw (PL); Grzegorz Malachowicz, Wroclaw (PL); Olympia Gladysz, Wroclaw (PL); Stanislawa Plinska, Oborniki Slaskie (PL); Andrzej Kozakiewicz, Krakow (PL); Boguslaw Bas, Krakow (PL); Jacek Nowak, Legnica (PL); Krzysztof Urbanowicz, Legnica (PL); Marek Slomka, Lubin (PL); Andrzej Rapacz, Legnica (PL)

Correspondence Address: Horst M Kasper, 13 Forest Drive, Warren, NJ, 07059, US

(21) Appl. No.: 10/363,360

(22) PCT Filed: Apr. 2, 2001
(86) PCT No.: PCT/PL01/00028

(30) Foreign Application Priority Data
Sep. 1, 2000 (PL) P.342328

(51) Int. Cl. G01N 27/26

(52) U.S. Cl. 205/789

(57) ABSTRACT

The method consists in registering curves by cyclic voltammetry method in the range of copper ion concentration up to 20 g/l or alternately by chronoamperometric method in the range of concentration from 20 to 60 g/l. A platinum or gold microprobe of a diameter in the range from 1 to 50 um and a copper plate reference electrode are used. The value of current density read off from said curves is compared to the calibration curves previously determined by standard additions method. For high concentration in the range from 20 to 60 g/l the calibration curves obtained in the range of temperatures from 15 to 60° C. are registered.

### FIELD OH THE INVENTION

This invention relates to a method of measuring copper ion concentrations in industrial electrolytes in order to maintain optimum electrolyte composition which enables to obtain the highest quality copper at high current density efficiency of copper electrorefining process.

### BACKGROUND OF THE INVENTION

In order to obtain the highest quality copper the following chemical conditions must be fulfilled:

high concentration of Cu⁺⁺ at cathode surface,

steady level of surface-active additions concentration,

absence of slime particles at cathode surface,

low concentration of impurities in an electrolyte,

minimising temperature gradient in electrolyte tank.

Besides it is particularly important to measure continuously copper ions concentration in an electrolyte. The continuous measurement of said concentration guarantees maintaining a proper concentration level of copper and sulphuric acid in circulating electrolyte. In this way, optimum usage of a system and installation is preserved resulting in obtaining an electrolyte of proper and stable chemical composition for example in the last tank of cascade electrolysis process which enables to decrease the working time of the system and energy consumption.

Laboratory methods, most frequently used for determination of copper ion concentration in industrial electrolyte process are:

titration

spectrophotometry based measurements.

The information obtained using these methods do not have continuous character so the regulation processes based on them show significant deviations in relation to a set value. It is also impossible to control the processes in real time because there is a time shift between sampling and obtaining analysis results.

Electrochemical methods are widely used in chemical analysis. They are accurate, reproducible and enable to obtain repeated measurement results in a short period of time. Cyclic voltammetry (CV) and chronoamperometry (CA) are among the most widely used electrochemical methods. Cyclic voltammetry consists in measuring current density of a working electrode with linearly changing m time potential. Chronoaperometry consists in measuring current density of a working electrode in relation to time with unchanging in time potential.

As is known from the publication by M. Ciszkowska, Z. Stojek: Properties and Application of Voltamperometric Electrodes. Wiadomości Chemiczne. 1992/46/633, ultramicroelectrodes of different shapes are used for studies by electrochemical methods. An ultramicroelectrode is an electrode which has at least one linear dimension in the order of several micrometers. As a result it possesses a number of advantages such as:

low value of Ohmic resistance drop (on an uncompensated Ohmic resistance),

high transport rate of electroactive substances to and from electrode,

low value of time constant related to double layer charging process.

Ultramicroelectrodes, called later microprobes are made of platinum or gold. Reference electrodes are made of copper or platinum wire or plate. The pairs: microprobe-reference electrodes are experimentally chosen according to the kind and purpose of an electrochemical measurement.

### OBJECTS OF INVENTION

The invention relates to a method of copper ion concentration measurement in industrial electrolytes using electrochemical methods in the range of concentrations up to 60 g/l and electrolyte temperatures from 15 to 60° C.

The significance of the invention consists in using in accordance with the value of copper ion concentration either cyclic voltammetry (CV) or chronoamperometry (CA) in a two-electrode measuring system composed of a platinum or gold microprobe of a diameter in the range from 1 to 50 μm and a platinum or copper plate reference electrode. A voltamperometric curve is registered at the concentration up to 20 g/l, with the potential at the microprobe linearly changing in time, sweep rate from 50 to 2000 mV/s in the range from −400 to −900 mV. The value of current is read off from a plateau of current vs. potential curve, i.e. steady-state current of voltammetric wave segment. From said value, a value of base line current density read off from voltamperometric curve is subtracted. The difference between these values is then referred to previously determined calibration curve of current density vs. copper ion concentration. In the range of concentrations from 20 to 60 g/l a chronoamperometric curve is registered at a microprobe to which a double pulse potential signal of the values initially (first stage) from the range from −400 to −900 mV and subsequently (second stage) from 0 to +300 mV is applied and the value of current density is measured in the range from 0.05 to 1.0 s of the first stage duration from the moment of signal application. Copper ions concentration is read off from the previously determined family of calibration curves for the current density vs. copper ion concentration registered for chosen concentration values at temperatures in the range from 15 to 60° C.

It is advisable that calibration curve for voltammetric method is determined by standard additions method as a mean value of multiple current density measurements at the one chosen potential applied to a microprobe in the range from −4000 to −900 mV for added in succession selected copper sulphate additions using gold microprobe of a diameter 25 μm and platinum reference electrode.

It is advisable to determine the calibration curve for chronoamperometric method by standard additions method as a mean value of multiple current density measurements with the potential at the microprobe of −400 mV after 50-1000 ms from the moment of potential application for added in succession at least five selected copper sulphate additions, measuring current density for the determined concentration in at least five electrolyte temperatures in the range from 15 to 60° C. using gold microprobe of a diameter 25 μm and platinum or copper reference electrode.

The carried out studies proved that voltamperometry (CV) and chronoamperometry (CQA) used alternatively according to concentration range are the most suitable methods to measure copper ion concentration in industrial electrolytes because both methods show high selectivity of electrochemical measurements. Using an ultramicroelectrode as a working gold or platinum microprobe of a diameter from 1 to 50 μm ensures the possibility of achieving measurement accuracy of 1% even at the highest concentration up to 60 g/l.

The method presented in the invention is also advantageous because it does not require any initial treatment/processing of the industrial electrolyte such as de de-oxidation or dilution. Said method shows high reproducibility and reliability which enables to carry out the measurements for at least 4 weeks without maintenance in repeated measurement cycles lasting for about 5 minutes. A measurement cycle consisting of a curve registering i/U or i/time, current density value reading and referring it to the calibration curves and comparing previously measured values in order to determine copper ion concentration may be easily programmed and loaded into controlling system. Said measurements may be automated so the laboratory measurements are eliminated and the technological process is facilitated.

### BRIEF DESCRIPTION OF THE DRAWINGS

The object of the invention is described in the examples of its embodiments. The drawings are for illustrative purposes only.

FIG. 1 is a typical voltammetric curve;

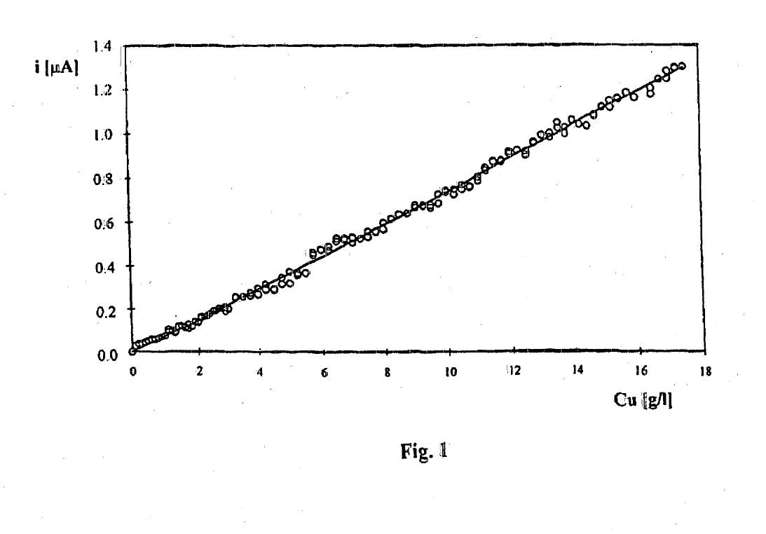

FIG. 2 is a voltammetric curve of an electrolyte in which copper ion concentration is below 20 g/l;

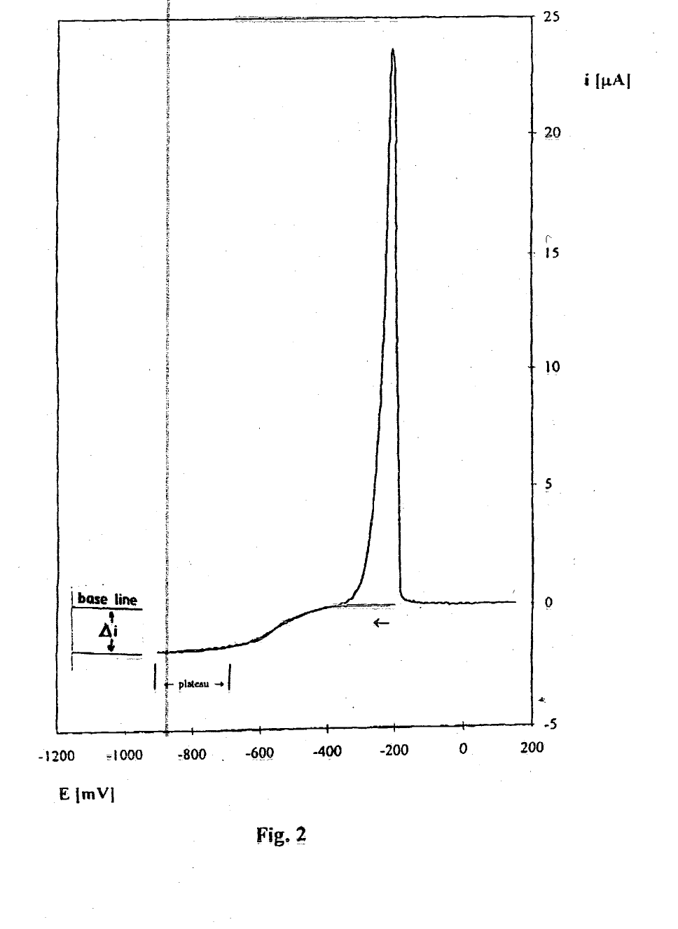

FIG. 3 shows a family of chronoamperometric calibration curves for the determined ion concentration in an electrolyte according to electrolyte temperature;

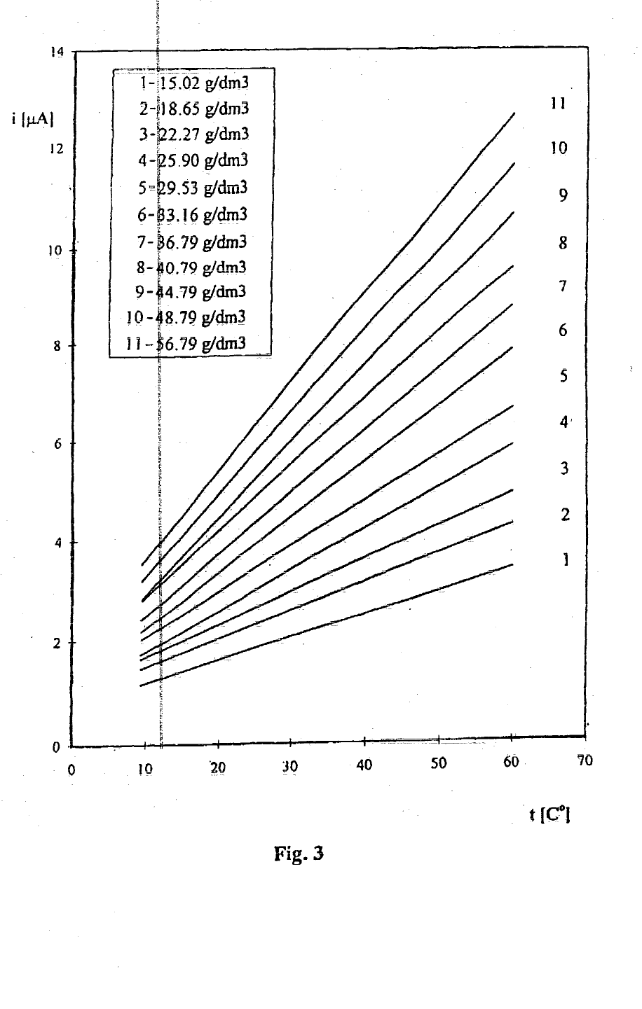

FIG. 4 shows a family of chronoamperometric calibration curves for four different temperatures;

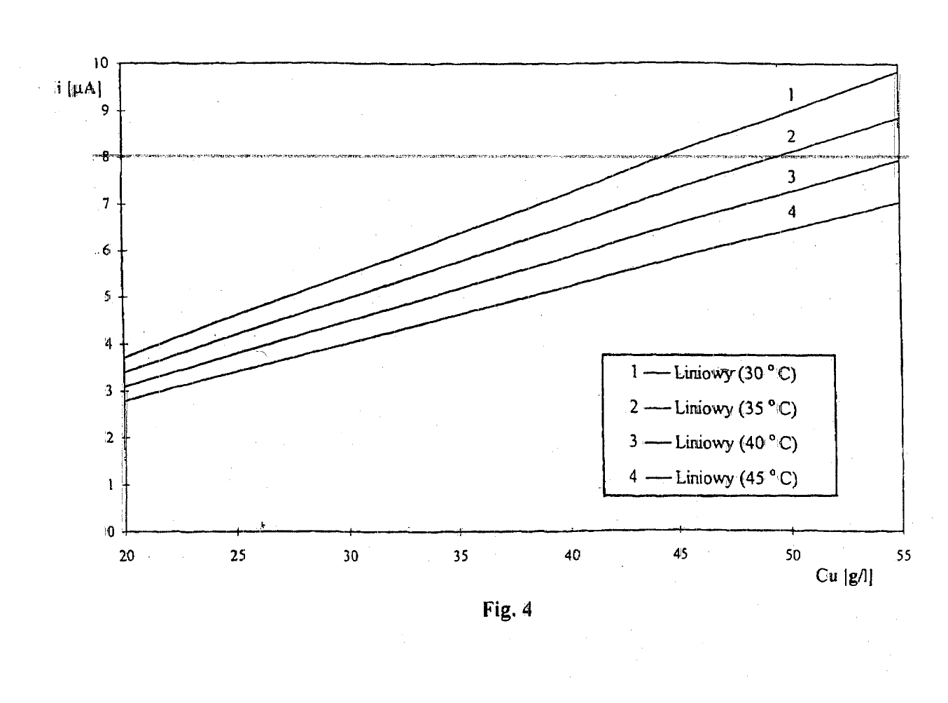

FIG. 5 is a dependence of current on ion concentration and electrolyte temperature;

FIG. 6 shows chronoamperometric curves of a given electrolyte, the copper ion concentration of which is about 47 g/l in six temperatures.

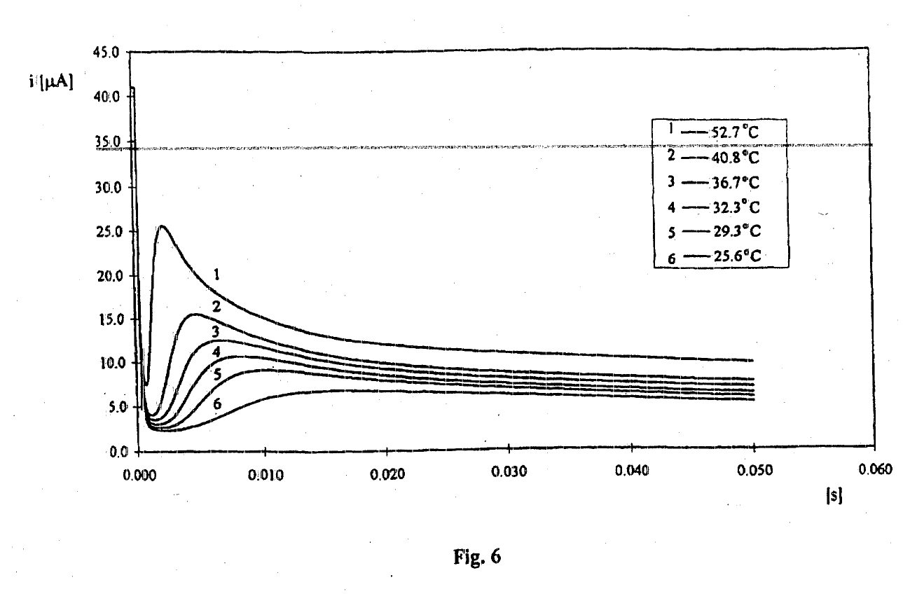

### EXAMPLES

The measurement of copper ion concentration described in the following examples is carried out in a two-electrode system composed of a measuring gold microprobe of a diameter 25 μm and reference electrode in the form of platinum or copper plate the surface of which is of about 0.3 cm². The electrodes are placed in a measuring cell filled with a flowing electrolyte and located in a Faradaic cage. The electrodes are connected with a well-known electrochemical measuring apparatus called potentiostat via a programmed controller. Cyclic voltammetty (CV) is used when the copper ion concentration value is below 20 g/l, whereas at the concentrations above 20 g/l and up to 60 g/l chronoamperometry (CA) is used. Each measurement is carried out in a cycle comprising several activities which last 1-2 minutes. The results are presented on the potentiostate monitor screen and the data are registered on the paper data carrier.

### Example I

### The Procedures Carried Out in Voltammetric Method (CV) are Described

Stage 1. Voltammetric method is used for obtaining a calibration curve for current density value in relation to copper ion concentration in 9 industrial solutions of the laboratory determined ion concentration in the range from 0.1 to 25 g/l. The measurements are carried out at a gold microprobe of a diameter 25 μm at applied initial potential of −900 mV changing in time at the velocity of 200 mV/s, at an electrolyte temperature of about 20° C. using a platinum reference electrode in the form of a plate the surface of which is 0.3 cm².

In order to determine copper ion concentration in the studied industrial solution, voltammetric current potential curve is registered and concentration is found from the calibration curve of current density value in relation to copper Cu(II) ion concentration in g/l.

Stage 2. Voltammetric method is used for obtaining a calibration curve after having introduced an industrial electrolyte into the measuring cell. The measurements are carried out at a gold microprobe at applied potential in the range from −200 to −900 mV and later from −900 to +200 mV, at potential changes at the sweep rate of 200 mV/s and temperature of 20° C. Current density readings are made every 1 ms. During potential transition from −900 mV to +200 mV copper deposit is removed from the microprobe.

The curve measured in the range tom 0 to −900 mV is projected on the monitor screen and current density of copper ion reduction is read off from a plateau segment appearing in the potential range from −650 to −900 mV then the current density value of base line extrapolated from the segment in the potential range from −200 to −350 mV is subtracted from it.

The current density difference of both plateau and base line currents, Δi is referred to previously registered calibration curve/relationship i/Cu in order to obtain copper Cu⁺⁺ ion concentration value in studied electrolyte. Said value is projected and registered; measurement time and electrolyte being marked.

Standard deviation in g/l is equal to 0.12 for the concentration of 19.55 g/l and to 0.08 for the concentration of 6.40 g/l which gives 0.6% and 1.25%, respectively. The duration of automated measurement cycle and reading do not exceed 2 minutes.

### Example II

### The Procedures Carried Out in Chronoamperometric (CA) Method are Described

Stage 1. Using chronoamperometric method a family of calibration curves/relationships of current density value in relation to electrolyte temperature for sufficiently high number (dozen or so) of ion concentrations in the industrial electrolyte is obtained by adding in succession sulphate copper portions, resulting concentrations being determined in laboratory by another analytical method. The measurement of a curve is carried out at a gold microprobe of a diameter 25 μm, at an applied potential of −400 mV duration of which is 84 ms using a reference electrode in the form of a copper plate, the surface of which is about 0.3 cm².

Calibration curves/relationships for selected in the studied range temperatures in current density vs. copper ion concentration co-ordinates are calculated from the following relation:

y=a(t)×Cu+b(t)

where

a—sensitivity coefficient,

t—temperature in ° C.,

Cu—copper ion concentration in g/l,

b—background coefficient.

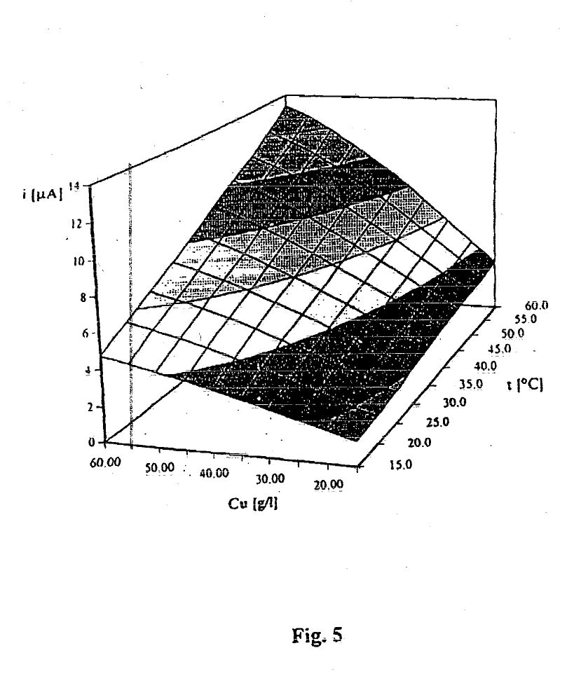

The determined calibration relationships are linear. The interdependence of current from ion concentration and temperature may be shown in the graph of FIG. 5 for 10 temperatures and 10 electrolyte concentrations. The graph prepared in this way is used for getting isothermal relationships between current and copper ions concentration using a computer program.

Stage 2. CA method is used for obtaining chronoamperometric curve/relationship after having introduced an industrial electrolyte sample into a measuring cell. Copper ion concentration in said electrolyte higher than 20 g/l can be shown in the preliminary measurement. A gold microprobe with the applied potential of −400 mV in relation to copper electrode, the potential being turned off after 84 ms. The current density is read off every 1 ms.

Said curve/relationship is projected onto the screen and registered, the measured current density being read off. Then the potential of +600 mV tuned off after 200 ms is applied to the microprobe in order to clean the microprobe from copper deposit. Copper ion concentration is read off from the calibration curve which is obtained for a given temperature from a series of dependencies of current vs. temperature for a known copper ion concentration.

Standard deviation in g/l for the concentration of 47.65 g/l is 0.05 g/l and for the concentration 41.16 g/l is 0.17 g/l which gives 0.11% and 0.42%, respectively. The duration of the measurement does not exceed 2 minutes.

1. A method of measuring copper ion concentration in industrial electrolytes using electrochemical analysis methods in the range of concentrations up to 60 g/l and electrolyte temperatures from 15 to 60° C., characterized in that, that according to the value of copper ion concentration, either cyclic voltammetry (CV) or chronoamperometry (CA) is used in two-electrode measuring system composed of a platinum or gold microprobe of a diameter in the range from 1 to 50 μm and a platinum or copper plate reference electrode, at the same time a voltamperometric curve is registered at the concentration up to 20 g/l, with the potential at the microprobe linearly changing in time at the sweep rate from 50 to 2000 mV/s in the range from −400 to −900 mV while. the value of current is read off from a plateau of current vs. potential curve, ie. steady-state current of voltammetric wave segment and from said value, a value of base line current density read off from voltamperometric curve is subtracted whereas the difference between these values is subsequently referred to previously determined calibration curve of current density vs. copper ion concentration while in the range of concentrations from 20 to 60 g/l, a chronoamperometric curve is registered at said microprobe to which a double pulse potential signal of the values initially (first stage) in the range from −400 to −900 mV and next (second stage) from 0 to +300 mV is applied and the value of current density is measured in the range from 0.05 to 1.0 s of the first stage duration from thee moment of signal application after which copper ion concentration is read off from the previously determined family of calibration curves for the current density vs. copper ion concentration registered for selected concentration values at temperatures in the range from 15 to 60°C.

2. The method defined in claim 1, characterized in that, that a calibration curve for voltammetric method is determined by standard additions method as a mean value of multiple current density measurements at one chosen potential applied to a microprobe in the range from −400 to −900 mV for being added in succession selected copper sulphate additions, using a gold microprobe of a diameter 25 μm and a platinum reference electrode.

3. The methods defined in claim 1, characterized in that, that a calibration curve for chronoamperometric method is determined by standard additions method as a mean value of multiple current density measurements with the potential at a microprobe of −400 m/V after 50-1000 ms from the moment of potential application for being added in succession at least five electrolyte temperatures in the range from 15 to 60° C., using a gold microprobe of a diameter 25 μm and a platinum or copper reference electrode.
